(19) United States
(12) Patent Application Publication
(10) Pub. No.: US 2026/0301764 A1
(43) Pub. Date: Oct. 1, 2026

(54) SECTOR REFRESH EVALUATION FOR MAGNETIC DATA STORAGE DISKS

(71) Applicant: Western Digital Technologies, Inc., San Jose, CA (US)

(72) Inventors: Wayne H. Vinson, Longmont, CO (US); Lena Hunicke-Smith, Longmont, CO (US)

(21) Appl. No.: 19/094,549

(22) Filed: Mar. 28, 2025

(51) Int. Cl. G11B 5/012

(52) U.S. Cl. CPC G11B 5/012

(57) ABSTRACT

A Data Storage Device (DSD) includes one or more disks that each includes at least one recording surface configured to store data in a plurality of tracks, and each track includes sectors. An indication of accumulated magnetic interference for a sector range in a track is determined to have reached or exceeded a partial refresh threshold value used to determine whether to perform a refresh operation to rewrite data stored in the sector range. Based at least in part on at least one indication of accumulated magnetic interference for at least one corresponding adjacent sector range in a corresponding adjacent track, it is determined whether to perform the refresh operation on the sector range. According to one aspect, the probability of triggering an additional refresh operation on the adjacent sector range is considered in determining whether to perform the refresh operation on the sector range.

### BACKGROUND

Data Storage Devices (DSDs) are often used to record data onto or to reproduce data from storage media. One type of storage media includes a rotating disk, such as in a Hard Disk Drive (HDD). In such DSDs, user data is magnetically stored in sectors arranged in concentric circular tracks on the disk surfaces. In such DSDs, a head is positioned in relation to a recording surface on the disk to magnetically read and write data in the concentric tracks on the recording surface.

The amount of data that can be stored in a given area on the recording surface (i.e., an areal density) generally continues to increase with each new generation of DSDs that use a disk to store data. New technologies have been introduced or are in development to allow DSD heads to increase the track density on a recording surface (e.g., increase the Tracks Per Inch (TPI)), using for example, various energy-assisted recording techniques, such as Thermal Fly-Height Control (TFC), Heat Assisted Magnetic Recording (HAMR), and Microwave Assisted Magnetic Recording (MAMR). Such technologies typically reduce the scale or physical size of the recorded data to increase the TPI but can make the data stored in a track more susceptible to magnetic interference when writing data in nearby tracks.

This magnetic interference can include Adjacent Track Interference (ATI) where repeated writes to an adjacent track corrupts or erases data in a track and causes errors when reading the data stored in the track. Even repeated writes to tracks farther from the track, such as up to thirty tracks away, can have a cumulative effect in corrupting the data stored in the track.

To counter magnetic track interference, DSDs typically count the number of write operations performed in each adjacent track and refresh the data in the track by rewriting the data stored in the track after a predetermined number of write operations have been performed in adjacent and/or other proximate tracks. However, such refresh operations can decrease the efficiency of the DSD by reducing the time and processing resources available for performing host commands. In addition, rewriting the data for the refresh operation increases the write counts for adjacent tracks, which increases the overall number of refresh operations that need to be performed. On the other hand, reducing the effect of magnetic track interference by performing more refresh operations can facilitate a higher track density by offsetting the increase in magnetic track interference caused by positioning tracks closer together to increase data storage capacity.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a plan view of an example Data Storage Device (DSD) according to one or more embodiments.

FIG. 2 illustrates an example of determining whether to perform refresh operations on sector ranges in a track according to one or more embodiments.

FIG. 3 is a flowchart for a track evaluation process according to one or more embodiments.

FIG. 4 is a flowchart for a sector range refresh evaluation process according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example Data Storage Device

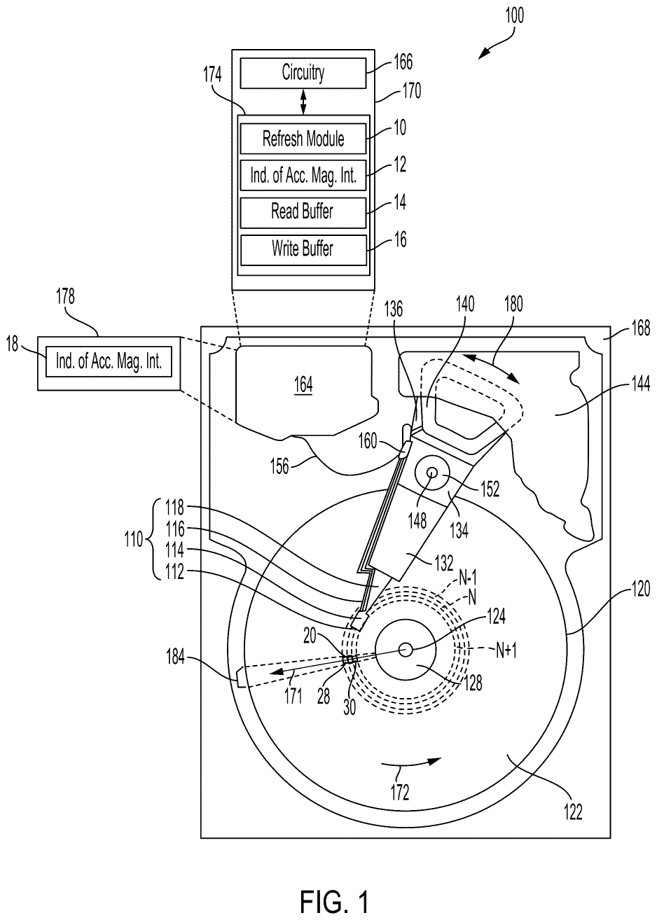

FIG. 1 is a plan view of an example Data Storage Device (DSD) 100 according to one or more embodiments to illustrate an exemplary operating environment. In some implementations, DSD 100 can include a Hard Disk Drive (HDD) or other type of DSD including a rotating magnetic disk as a data recording medium, such as a Solid-State Hybrid Drive (SSHD) that can include solid-state non-volatile memory in addition to one or more disks.

As shown in the example of FIG. 1, DSD 100 includes slider 114 that includes magnetic reading/recording head 112. Collectively, slider 114 and head 112 may be referred to as a head slider. DSD 100 further includes at least one Head Gimbal Assembly (HGA) 110 including the head slider, lead suspension 116 attached to the head slider typically via a flexure, and load beam 118 attached to lead suspension 116.

DSD 100 also includes at least one disk 120 rotatably mounted on spindle 124 using disk clamp 128. A drive motor (not visible) is attached to spindle 124 for rotating disk 120. Head 112 includes a writer or write element and a reader or read element for respectively writing and reading data stored on recording surface 122 of disk 120. In some implementations, disk 120 can include a second recording surface on the opposite side of disk 120 beneath recording surface 122. In such implementations, HGA 110 can include an additional head slider spaced apart from slider 114 and head 112 to read and write data on the additional recording surface of disk 120. In addition, and as appreciated by those of ordinary skill in the art, additional disks with recording surfaces may be stacked below disk 120 and affixed to spindle 124 with disk clamp 128, and HGA 110 can include additional spaced apart head sliders for reading and writing data from respective recording surfaces.

As shown in FIG. 1, DSD 100 further includes arm 132 attached to HGA 110, carriage 134, a Voice-Coil Motor (VCM) that includes armature 136 and voice coil 140 attached to carriage 134 and stator 144 including a voice-coil magnet (not visible). Armature 136 of the VCM is attached to carriage 134 and is configured to move arm 132 and HGA 110, to access portions of disk 120, being mounted on pivot shaft 148 with interposed pivot-bearing assembly 152. In the case of multiple disks, carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a Head Stack Assembly (HSA). An HSA may, however, include more or fewer components than those described. For example, an HSA may refer to an assembly that further includes electrical interconnection components. Generally, an HSA is the assembly configured to move the head slider to access portions of the disk 120 for read and write operations.

With further reference to FIG. 1, electrical signals (e.g., current to voice coil 140 of the VCM) comprising a write signal to and a read signal from head 112 are provided by flexible interconnect cable 156 (“flex cable”). Arm-Electronics (AE) module 160, which may have an on-board pre-amplifier for the read signal, as well as other read-channel and write-channel electronic components, provides connection between flex cable 156 and head 112. AE module 160 may be attached to carriage 134 as shown or may be included as part of circuitry 166 of controller 170. Flex cable 156 is coupled to electrical connector block 164, which provides electrical communication to controller 170 located beneath electrical connector block 164 through electrical feedthroughs provided by base or housing 168. In conjunction with a cover, housing 168 provides a sealed, protective enclosure for the data storage components of DSD 100.

Other electronic components, including a disk controller and servo electronics that can further include a Digital Signal Processor (DSP), provide electrical signals to the drive motor, voice coil 140 of the VCM, and head 112 of the HGA 110. The electrical signal provided to the drive motor enables the drive motor to spin, providing a torque to spindle 124, which is in turn transmitted to disk 120 that is affixed to spindle 124. As a result, disk 120 spins in direction 172. The disk 120 creates a gas cushion that acts as a gas-bearing on which the Gas-Bearing Surface (GBS) of slider 114 rides so that slider 114 flies above the surface of disk 120 without contacting a thin magnetic-recording layer of recording surface 122 in which data is recorded.

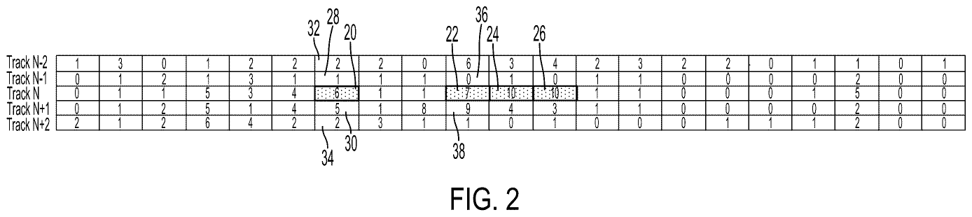

The electrical signal provided to voice coil 140 of the VCM enables head 112 of HGA 110 to access tracks, such as tracks N, N−1, and N+1, in which data is recorded. Thus, armature 136 of the VCM swings through an arc 180, which enables head 112 of HGA 110 to access various tracks on disk 120. Data is stored on recording surface 122 of disk 120 in a plurality of radially nested tracks arranged in sectors on disk 120, such as sectors 20, 28, and 30 in tracks N, N−1, and N+1, respectively. As discussed in more detail below with reference to FIG. 2, sectors 20, 28, and 30 are arranged in the same radial direction 171 within wedge 184, with sector 20 of track N being adjacent to both sectors 28 and 30 in radial direction 171. In this regard, each of tracks N−1 and N+1 is considered an adjacent track to track N.

Each track on recording surface 122 is composed of a plurality of sectors, such as sectors 20, 28, and 30, that may store recorded data and a header containing a servo-burst-signal pattern. The servo-burst signal pattern may include, for example, an ABCD-servo-burst-signal pattern, which is information that identifies the track, and error correction code information. In accessing track N, the read element of head 112 of HGA 110 reads the servo-burst-signal pattern, which provides a Position-Error-Signal (PES) to the servo electronics, which controls the electrical signal provided to voice coil 140 of the VCM, enabling head 112 to follow track N. Upon finding track N and identifying sector 20, head 112 either reads data from track N or writes data to track N depending on instructions, such as instructions received by controller 170 from an external host, such as a microprocessor of a computer system, or instructions executed by circuitry 166, such as refresh module 10, to rewrite data in particular sectors.

In the example of FIG. 1, controller 170 is shown with dashed lines connected to electrical connector block 164 to indicate that controller 170 is in electrical communication with electrical connector block 164. As will be appreciated by those of ordinary skill in the art, controller 170 in some implementations can include a Printed Circuit Board (PCB) coupled to the bottom side of DSD 100, such as to housing 168. As shown in the example of FIG. 1, controller 170 includes circuitry 166 and at least one memory 174, which can include a Dynamic Random Access Memory (DRAM) or other solid-state memory, such as a Storage Class Memory (SCM) used to access data quickly.

While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, Electrically Erasable Programmable Read-Only Memory (EEPROM), Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), Magnetoresistive RAM (MRAM), and/or other discrete Non-Volatile Memory (NVM) chips, or any combination thereof.

Circuitry 166 can comprise electronic components for performing different functions for operation of the DSD, such as an interface controller, a Read/Write Integrated Circuit (R/W IC), an AE module, a motor driver, a servo processor, and other digital processors and associated memory. In this regard, circuitry 166 can include one or more processors for executing instructions, such as a microcontroller, a DSP, an Application-Specific Integrated Circuit (ASIC), a Field Programmable Gate Array (FPGA), a Graphics Processing Unit (GPU), hard-wired logic, analog circuitry, and/or a combination thereof. In some implementations, circuitry 166 can include a System on a Chip (SoC), which may also include one or more memories of at least one memory 174.

As shown in FIG. 1, at least one memory 174 stores (individually or in combination) refresh module 10, indications of accumulated magnetic interference 12, read buffer 14, and write buffer 16. Refresh module 10 can include computer-executable instructions executed by circuitry 166 for refreshing particular sectors or sector ranges on a recording surface of disk 120. As discussed above, magnetic interference caused by writes to adjacent tracks (i.e., Adjacent Track Interference (ATI)) and/or to other nearby tracks (e.g., Far Track Interference (FTI) and Near Track Interference (NTI)) can cause corruption or erasure of data stored in a track.

Refresh module 10 can account for the accumulated magnetic interference to a particular sector range on recording surface(s) of disk 120 that may be caused by writes to adjacent and/or other nearby sectors on the recording surface using indications of accumulated magnetic interference 12. As used herein, a “sector range” refers to one or more sectors in a single track that is less than all of the sectors in the single track. In some implementations, the accumulated magnetic interference accounted for a sector range can be for individual sectors. In other implementations, the accumulated magnetic interference accounted for a sector range can be for multiple circumferentially contiguous or nearly contiguous sectors in a track, such as for groups of two or four contiguous sectors.

Based on the indication of accumulated magnetic interference for the particular sector range, refresh module 10 can determine whether to rewrite the data stored in the sector range to maintain the integrity of the data stored in the sector range. As used herein, indications of accumulated magnetic interference for sector ranges can be based on writes to adjacent sector ranges in adjacent tracks, writes to other proximate sector ranges in proximate tracks that are farther than an adjacent track (e.g., NTI and/or FTI), a head skew or tilting of the head at different radial locations on the disk that directs more magnetic interference in a particular direction, and/or environmental conditions that affect magnetic interference, such as a DSD temperature when particular adjacent or proximate writes occur.

Notably, refresh module 10 not only considers the expected magnetic interference incurred by the particular sector range in determining whether to refresh the sector range but also considers the expected increase in magnetic interference to adjacent sector ranges in adjacent tracks that would be caused by performing the refresh operation on the particular sector range. As discussed in more detail below, this can decrease the overall number of refresh operations that need to be performed, since some refresh operations to particular sector ranges can be deferred to reduce the likelihood of triggering refresh operations for nearby sector ranges.

As opposed to rewriting all the data stored in a full track, DSD 100 instead uses partial track refresh operations to rewrite data stored in particular sector ranges (e.g., individual sectors or a predetermined number of contiguous sectors) within a track that may have indications of accumulated magnetic interference or “write counts” that reach or exceed a refresh threshold value. In some implementations, one or more sector ranges within a track may have indications of accumulated magnetic interference that reach or exceed a forced refresh threshold value that triggers a refresh operation on the one or more sector ranges to rewrite the data stored in the sector range or ranges. In such implementations, one or more sector ranges reaching the forced refresh threshold value can also cause the evaluation of each of the other sector ranges in the track to determine whether to proactively refresh sector ranges that have a relatively high indication of accumulated magnetic interference.

For example, a sector range may reach a forced refresh threshold value of ten writes to adjacent sector ranges and need to be rewritten. Refresh module 10 may then check each sector range in the same track to determine if any of the other sector ranges have reached or exceeded a partial refresh threshold value of six writes and determine for such sector ranges whether rewriting the sector range would increase or decrease the probability of needing to perform another refresh operation on its adjacent sector ranges within a predetermined number of future writes. In some implementations, refresh module 10 can further consider an overall change caused by refreshing the sector range in the total probability of performing an additional refresh operation on any one of the sector ranges in a group including the sector range and its adjacent sector ranges within a predetermined number of future writes performed to the group as a whole. By considering the impact of refresh operations on adjacent tracks, the overall number of refresh operations can be reduced per sector range, which increases the efficiency of the DSD's write performance and may also enable closer track pitches that can increase the overall data storage capacity of the DSD.

Read buffer 14 can be used by circuitry 166 to buffer data that is read from a recording surface of disk 120, such as data that may be read for rewriting data to a sector range for a refresh operation or data that is buffered to be returned to a requesting host that sent a read command to the DSD. In this regard, read buffer 14 can be viewed as a shared resource for both performing host read commands and for performing refresh operations. A reduction in refresh operations can result in a higher performance of DSD 100, such as a higher Input/output Operations Per Second (IOPS) metric, by enabling a greater amount of data to be read from recording surfaces into read buffer 14 within a given period of time.

Write buffer 16 can be used by circuitry 166 to buffer data that is to be written on a recording surface of disk 120, such as data that is to be rewritten to a sector range for a refresh operation or data that is buffered to be written to the recording surface for performing a write command received from a host. In this regard, write buffer 16 can be viewed as a shared resource for both performing host write commands and for performing refresh operations. A reduction in refresh operations can result in a higher performance of DSD 100, such as a higher IOPS metric, by enabling a greater amount of data to be buffered in write buffer 16 to be written on recording surfaces within a given period of time.

In the example of FIG. 1, DSD 100 includes Non-Volatile Memory (NVM) 178, which can include a solid-state memory. NVM 178 stores indications of accumulated magnetic interference 18, which can include indications of accumulated magnetic interference for every sector range or every currently used or valid sector range of the recording surfaces of disks in DSD 100. NVM 178 may be used to provide the relatively large amount of storage capacity needed to keep track of the indications of accumulated magnetic interference for the significant number of sector ranges on the recording surfaces.

In some implementations, indications of accumulated magnetic interference 12 in the at least one memory 174 are accumulated into a block size used by NVM 178 to write data so that the indications of accumulated magnetic interference can be stored in a larger storage capacity of NVM 178. When determining whether to perform a refresh operation on a particular sector range, refresh module 10 may identify the most recent versions of the indications of accumulated magnetic interference for the sector range and its proximate sector ranges. One or more sector locations or sector IDs may be used in the indications of accumulated magnetic interference to determine if values from indications of accumulated magnetic interference 12 should be used as the most recent value, or if indications of accumulated magnetic interference 18 stored in NVM 178 should be accessed for the most recent value. Updates made to the indications of accumulated magnetic interference for writes, whether for refreshing a sector range or for performing host write commands, are made in memory or memories 174. In some implementations, updates to memory or memories 174 may be performed quicker than updates to NVM 178 due to the type of memory being used (e.g., DRAM versus flash memory).

As will be appreciated by those of ordinary skill in the art with reference to the present disclosure, other implementations of DSD 100 may differ from the example shown in FIG. 1. For example, other implementations of DSD 100 may not include NVM 178 in favor of non-volatilely storing all of the indications of accumulated magnetic interference in memory or memories 174. As another example variation, refresh module 10 may include multiple modules that control different portions of the refresh process, such as by having a module for tracking the indications of accumulated magnetic interference, a module for determining whether to perform refresh operations, and a module for performing the refresh operations. Those of ordinary skill in the art will also appreciate that the sectors and tracks shown in FIG. 1 are for the purposes of illustration and that recording surface 122 in FIG. 1 can include many more sectors and tracks at a much smaller scale with recording surface 122 including, for example, tens of thousands of tracks.

FIG. 2 illustrates an example of determining whether to perform refresh operations on sector ranges in track N of FIG. 1 according to one or more embodiments. As shown in FIG. 2, sector ranges are represented by boxes arranged in rows that correspond to tracks on recording surface 122. The indication of accumulated magnetic interference for each sector range is shown inside the box for the sector range. In some implementations, each sector range can be a single sector. In other implementations, each sector range can be a predetermined number of contiguous sectors, such as two or four sectors.

In the example of FIG. 2, the forced refresh threshold value for triggering a refresh operation for a sector is ten. Reaching or exceeding the forced refresh threshold value for any sector range in a track also causes an evaluation of other sector ranges in the same track that have indications of accumulated magnetic interference that have reached or exceeded a partial refresh threshold value of six.

In the example of FIG. 2, sector ranges 24 and 26 in track N have indications of accumulated magnetic interference of ten that have reached the forced refresh threshold value. Sector ranges 24 and 26 can therefore be added to a list of sector ranges to be refreshed or rewritten to maintain the integrity of the data stored in the sector ranges. In this regard, a refresh operation can be performed on a sector range to rewrite the data stored in the sector range to reset its indication of accumulated magnetic interference to zero and maintain the integrity of the data stored in the sector range. Sector ranges 20 and 22 are identified as other sector ranges in track N that have reached or exceeded the partial refresh threshold value of six. As a result, it is determined whether a refresh operation should be performed on these sector ranges based, at least in part, on the indications of accumulated magnetic interference for their adjacent sector ranges in Tracks N−1 and N+1. For sector range 20, indications of accumulated magnetic interference for adjacent sector ranges 28 and 30 in adjacent tracks N−1 and N+1, respectively, are considered in determining whether to perform a refresh operation on sector range 20. For sector range 22, indications of accumulated magnetic interference for adjacent sector ranges 36 and 38 in adjacent tracks N−1 and N+1, respectively, are considered in determining whether to perform a refresh operation on sector range 22.

This consideration of the accumulated magnetic interference on adjacent sector ranges can reduce an overall number of refresh operations, since some refresh operations that could be deferred or delayed would trigger one or more additional refresh operations or generally increase the probability of additional refresh operations being performed in the near future. For example, performing a refresh operation on sector range 22 in track N will trigger an additional refresh operation of its adjacent sector range 38 in track N+1, because the refresh operation of sector range 22 will increase the indication of accumulated magnetic interference of adjacent sector range 38 to the forced refresh threshold value of ten, assuming each write to a sector range increases its adjacent sector range's indication of accumulated magnetic interference by one. As used herein, an adjacent sector range can refer to a sector range in the same radial direction in an adjacent track (i.e., the next or previous track) on the disk's recording surface. In some implementations, the refresh operation of sector range 22 will also cause the additional processing of checking each sector range in adjacent track N+1 to determine if any other sector ranges in the track have reached or exceeded the partial refresh threshold value, and potentially cause further refresh operations.

In some implementations, the determination of whether to perform a refresh operation on a sector range that has reached or exceeded the partial refresh threshold value can be simply whether performing the refresh operation on the sector range will cause an additional refresh operation in an adjacent track. In such implementations, the refresh operation may be deferred for sector range 22, since it would trigger an additional refresh operation on its adjacent sector range 38.

In some implementations, writes to sectors that are farther than an adjacent sector range in the same radial direction as the sector range may also increase the indication of accumulated magnetic interference, such as by a fraction of the increase caused by writes to an adjacent sector range. For example, each write to sector range 32 or to sector range 34 in track N−2 or track N+2, respectively, may increase the indication of accumulated magnetic interference of sector range 20 by 0.25. In some implementations, a temperature or other environmental condition, such as an estimated disk surface temperature may be used to scale the increase or decrease to the indication of accumulated magnetic interference caused by a write.

In addition, the increase to the indication of accumulated magnetic interference in some implementations can vary depending on the concentric location of the head over the recording surface and the side of the track from where the write occurs (i.e., on an Inner Diameter (ID) side of the track or on an Outer Diameter (OD) side of the track). Such a variation in the indication of accumulated magnetic interference can be due, for example, to a head skew that may occur in a circumferential ID region or a circumferential OD region of the recording surface when the head may be more tilted or non-parallel to the recording surface and impart more magnetic interference to one side of the written track than to the other side. Writing in a Middle Diameter (MD) circumferential region, where a surface of the head facing the recording surface is generally parallel to the recording surface, may impart a relatively equal amount of magnetic interference to both sides of the written track.

As discussed in more detail below, some implementations of determining whether to perform a refresh operation on a sector range may include determining an adjacent probability of the indication of accumulated magnetic interference for an adjacent sector range reaching or exceeding a forced refresh threshold value within a predetermined number of adjacent proximate writes if the refresh operation were performed on the sector range. For example, the determination of whether to perform a refresh operation on sector range 20 can include determining the probability (“adjacent probability”) of causing an additional refresh operation for sector range 28 in adjacent track N−1 and/or for sector range 30 in adjacent track N+1 within a predetermined number of adjacent proximate writes.

In some implementations, the adjacent probability may only be calculated for the adjacent sector range having the higher indication of accumulated magnetic interference or for one of the adjacent sector ranges if each adjacent sector range has the same value for its indication of accumulated magnetic interference. In such implementations, a threshold increase in probability may be used for determining whether to perform the refresh operation on the evaluated sector range. For example, if the change (“adjacent change”) in the adjacent probability of sector range 30 in FIG. 2 reaching or exceeding the forced refresh threshold value within the predetermined number of adjacent proximate writes if a refresh operation were performed on sector range 20 indicates an increase of 30% or more, then the refresh operation on sector range 20 may be deferred until it is reevaluated again or until its indication of accumulated magnetic interference reaches or exceeds the forced refresh threshold value.

In other implementations, the adjacent probability of the adjacent sector range reaching or exceeding the forced refresh threshold value may be used instead of a change in the adjacent probability. For example, if the adjacent probability of sector range 30 in FIG. 2 reaching or exceeding the forced refresh threshold value if the refresh operation were performed on sector range 20 indicates more than a threshold probability, such as an adjacent probability of 80% or more within the predetermined number of adjacent proximate writes, then the refresh operation on sector range 20 is deferred until it is reevaluated again or until its indication of accumulated magnetic interference reaches or exceeds the forced refresh threshold value.

In some implementations, a predetermined number of proximate writes can be based on a number of writes to a group of sector ranges in the same radial direction that are centered about the sector range being evaluated for a refresh operation. For example, a predetermined number of adjacent proximate writes can be the next ten writes cumulatively made to a group of sector ranges including the sector range being evaluated and its two adjacent sector ranges in the same radial direction. In some implementations, the predetermined number of proximate writes can be based on the forced refresh threshold value for triggering a refresh operation. In addition, the predetermined number of proximate writes may consider a ratio of the forced refresh threshold value to a total indication of accumulated magnetic interference increase to the group of sector ranges caused by a write to the sector range being evaluated. Although the predetermined number of proximate writes may be a calculated value, the predetermined number of proximate writes may be set in a firmware for the DSD and may be used for all of the recording surfaces of the DSD in some implementations. In this regard, the DSD itself may not calculate the predetermined number of proximate writes, and this value may be a fixed value for the DSD in some implementations.

With reference to the example of FIG. 2, the predetermined number of proximate writes can equal the forced refresh threshold value of ten divided by two, which is the indication of accumulated magnetic interference incurred by each adjacent sector range for a given write to a sector range between its two adjacent sector ranges. In this example, the predetermined number of proximate writes represents an epoch or timeframe during which five writes cumulatively occur to a group of sector ranges as a whole that are in the same radial direction and centered about the sector range being evaluated for a probability of its indication of accumulated magnetic interference reaching or exceeding the forced refresh threshold within the predetermined number of proximate writes to the group.

In some implementations, a local probability of a sector range's indication of accumulated magnetic interference reaching or exceeding the forced refresh threshold within a predetermined number of local proximate writes may also be calculated. For the example of sector range 20 in FIG. 2, the predetermined number of local proximate writes represents an epoch during which five writes will cumulatively occur to any of sector ranges 20, 28, and 30 as a group.

The adjacent probability of an additional refresh operation to either adjacent sector range 28 or to adjacent sector range 30 within the predetermined number of adjacent proximate writes increases by performing the refresh operation on sector range 20, since rewriting the data stored in sector range 20 increases the indications of accumulated magnetic interference for adjacent sector ranges 28 and 30. In some implementations, the probability of a sector range reaching or exceeding the forced refresh threshold value in the next epoch of proximate writes can be expressed as:

$$P = {( \frac{2}{3} )}^{\frac{2 ( FRT - MIC )}{\sum Risk Vector}} . \qquad Equation 1$$

In determining the probability, P, using Equation 1 for sector range 20, FRT is the forced refresh threshold value of ten, MIC is the current indication of accumulated magnetic interference of six for sector range 20, and (⅔) represents the probability of a write during the epoch of five writes occurring to adjacent sector range 28 or to adjacent sector range 30, as opposed to the write occurring to sector range 20, which would reset its indication of accumulated magnetic interference. The summation of the risk vector in Equation 1 is the total increase in the indications of magnetic interference for a write. In this example, the sum of the risk vector is two, since each write causes an increase of one for each adjacent sector range's indication of accumulated magnetic interference. In Equation 1, it is an average risk of accumulated magnetic interference or “damage” that is considered by dividing the sum of the risk vector by two, which simplifies into doubling the numerator (FRT-MIC) in Equation 1.

As noted above, some circumferential regions of the recording surface, such as an OD or ID region, may receive different levels of magnetic interference on the different sides of a track being written in the region. The adjacent and/or proximate tracks on the two different sides of the track being written will then incur different amounts of magnetic interference that can be represented by different increases in the respective indications of accumulated magnetic interference for adjacent or proximate sector ranges depending on whether the adjacent or proximate sector ranges are located on an ID side or on an OD side of the sector range being written. The sum of the risk vector may add the magnetic interference increases from both sides of the track and then provide an average effect for each write in Equation 1 by dividing by two for each side of the write.

As discussed above, other implementations may consider the magnetic interference effects from writes that occur farther away from the sector, such as for NTI and/or FTI. In such implementations, the risk vector can be expanded to include these farther tracks, and the forced refresh threshold value may be increased. For example, a forced refresh threshold value may be thousands of writes, and the sector ranges considered for magnetic interference could include sixteen sector ranges on each side of the write to provide a much larger forced refresh threshold value, and may provide a larger predetermined number of proximate writes for the larger group of sector ranges. Equation 1 may then change to replace the base of (⅔) for a probability of a write occurring outside the sector range being evaluated with a base of ( 32/33) raised to an exponent including a more complex risk vector that may consider the proximity of the sector ranges in the group in summing the risk vector. Although calculating the probability of reaching or exceeding the forced refresh threshold value this way may be more accurate, the increase in computational complexity for the DSD's memory and processing resources may not be worth the additional accuracy, as compared to only considering the adjacent sector ranges or a smaller number of proximate sector ranges, such as two sector ranges on either side of the sector range being evaluated.

In some implementations, the greater effect of magnetic interference from the two sides of the evaluated sector range in the group of sector ranges may instead be used in determining the probability, as opposed to using an average effect of the magnetic interference from the two sides as in Equation 1. In such implementations, the probability of a sector range's indication of accumulated magnetic interference reaching or exceeding the forced refresh threshold value in the next epoch of proximate writes can be expressed as:

$$P = {( \frac{2}{3} )}^{\frac{( FRT - MIC )}{max ( Risk Vector )}} . \qquad Equation 2$$

As noted above, the adjacent and/or proximate tracks on the two different sides of the track being written may incur different amounts of magnetic interference that can be represented by different increases in the respective indications of accumulated magnetic interference for adjacent or proximate sector ranges, depending on whether the adjacent or proximate sector ranges are located on an ID side or on an OD side of the sector range being written. In such cases, Equation 2 above could use the increase in the indication of accumulated magnetic interference for the side of the track that incurs the greater increase (i.e., max (Risk Vector) in Equation 2) in determining the probability of an evaluated sector range reaching or exceeding the forced refresh threshold value in the next epoch of proximate writes to the group of sector ranges.

In some implementations, the determination of whether to perform a refresh operation on a sector range can be made based on an overall change in a total probability of an additional refresh operation in the group of sector ranges within the predetermined number of proximate writes. In such implementations, the DSD may determine the individual changes in probability for each sector range in the group, or for a subset of the group of sector ranges, that would be caused by performing the refresh operation. This can include determining a local change to a local probability of the evaluated sector range's indication of accumulated magnetic interference reaching or exceeding the forced refresh threshold value within the predetermined number of proximate writes to the group of sector ranges, and determining changes (“adjacent or proximate changes”) in one or more adjacent or proximate probabilities of adjacent or proximate sector ranges' indications of accumulated magnetic interference reaching or exceeding the forced refresh threshold value within the predetermined number of proximate writes to the group of sector ranges if the refresh operation were performed.

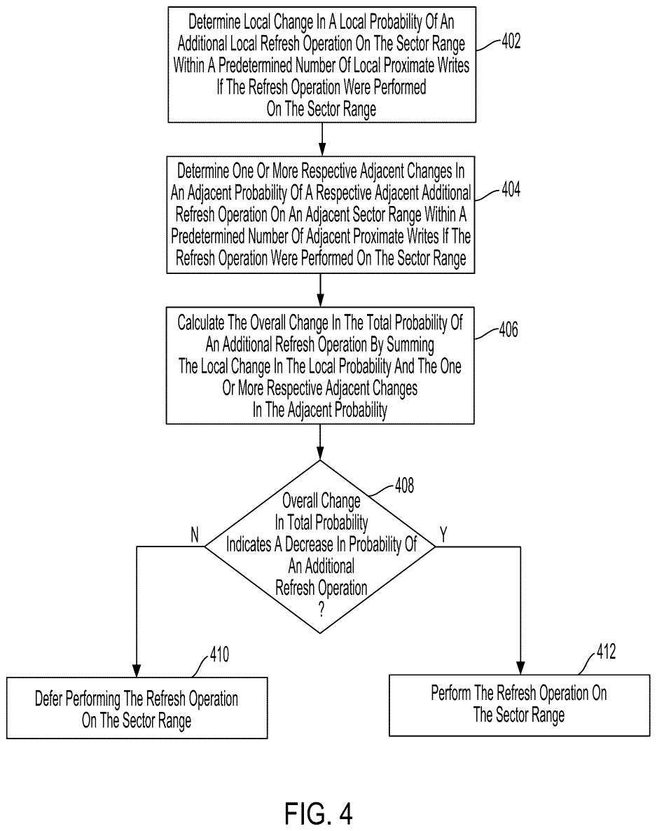

The overall change in the total probability of an additional refresh operation within the group of sector ranges if the refresh operation were performed would then be the sum of the change (“local change”) in the local probability and the changes (“adjacent or proximate changes”) in the adjacent or proximate probabilities. In this regard, performing the refresh operation on the evaluated sector range would decrease the local probability, because the indication of accumulated magnetic interference for the evaluated sector range would reset to zero. On the other hand, performing the refresh operation on the evaluated sector range would increase the adjacent or proximate probabilities, because the indications of accumulated magnetic interference for these sector ranges would increase due to rewriting the evaluated sector range. As discussed in more detail below with reference to the process of FIG. 4, the refresh operation can be performed in cases where its performance would decrease the total probability, and the refresh operation can be deferred in cases where its performance would increase the total probability.

With reference to the example of sector 20 in FIG. 2, a local change in a local probability of the indication of accumulated magnetic interference for sector range 20 reaching or exceeding the forced refresh threshold value is calculated using Equation 1 above. The local probability is calculated for the case where the refresh operation is performed on sector range 20, which would reset the indication of accumulated magnetic interference (i.e., MIC in Equation 1 becomes zero). Using a forced refresh threshold value (i.e., FRT in Equation 1) of ten, the two in the numerator of the exponent is divided out by the two in the denominator of the exponent, and Equation 1 simplifies to

$${( \frac{2}{3} )}^{( 10 - 0 )} .$$

When calculated for the case where the refresh operation is not performed on sector range 20, Equation 2 simplifies to

$${( \frac{2}{3} )}^{( 10 - 6 )} .$$

The local change in the local probability caused by performing the refresh operation is then

$${( \frac{2}{3} )}^{10} - {( \frac{2}{3} )}^{4} ,$$

which results in a decrease of about 18.1% in the probability of the indication of accumulated magnetic interference for sector range 20 reaching or exceeding the forced refresh threshold value within the predetermined number of local proximate writes (i.e., five writes not including the refresh operation) to the group including sector range 20, adjacent sector range 28, and adjacent sector range 30.

Continuing with this example, the adjacent change in the adjacent probability of the indication of accumulated magnetic interference for adjacent sector range 28 reaching or exceeding the forced refresh threshold value can be calculated using Equation 1. The adjacent probability is calculated for the case where the refresh operation is performed on sector range 20, which would increase the indication of magnetic interference for adjacent sector range 28 by one. Equation 1 for adjacent sector range 28 then simplifies to

$${( \frac{2}{3} )}^{( 10 - 2 )}$$

for the case where the refresh operation is performed on sector range 20. When calculated for the case where the refresh operation is not performed on sector range 20, Equation 1 for adjacent sector range 28 simplifies to

$${( \frac{2}{3} )}^{( 10 - 1 )} .$$

The adjacent change in the adjacent probability caused by performing the refresh operation on sector range 20 is then

$${( \frac{2}{3} )}^{8} - {( \frac{2}{3} )}^{9} ,$$

which results in an increase of about 1.3% in the probability of the indication of accumulated magnetic interference for adjacent sector range 28 reaching or exceeding the forced refresh threshold value after performing the refresh operation on sector range 20 within five writes to an adjacent group of sector ranges centered about adjacent sector range 28. The adjacent group of sector ranges in this case would include sector range 20, adjacent sector range 28, and proximate sector range 32, which is in a proximate track (i.e., track N−2 in FIG. 2) that is adjacent to the adjacent track including adjacent sector range 28.

For adjacent sector range 30, the adjacent probability is calculated for the case where the refresh operation is performed on sector range 20, which would increase the indication of accumulated magnetic interference of adjacent sector range 30 by one. Equation 1 for adjacent sector range 30 simplifies to

$${( \frac{2}{3} )}^{( 10 - 6 )}$$

for the case where the refresh operation is performed on sector range 20. When calculated for the case where the refresh operation is not performed on sector range 20, Equation 1 for adjacent sector range 30 simplifies to

$${( \frac{2}{3} )}^{( 10 - 5 )} .$$

The adjacent change in the adjacent probability caused by performing the refresh operation is then

$${( \frac{2}{3} )}^{4} - {( \frac{2}{3} )}^{5} ,$$

which results in an increase of about 6.6% in the probability of the indication of accumulated magnetic interference for adjacent sector range 30 reaching or exceeding the forced refresh threshold value after performing the refresh operation on sector range 20 within five writes to an adjacent group of sector ranges centered about adjacent sector range 30. The adjacent group of sector ranges in this case would include sector range 20, adjacent sector range 30, and proximate sector range 34, which is in a proximate track (i.e., track N+2 in FIG. 2) that is adjacent to the adjacent track including adjacent sector range 30.

The overall change in the total probability of an additional refresh operation within respective predetermined numbers of proximate writes if the refresh operation is performed on sector range 20 is then the sum of the local change in the local probability and the adjacent changes in the adjacent probabilities. For the example discussed above, the overall change in the total probability would be −18.1%+1.3%+6.6%=−10.2%. Since the overall change in the total probability indicates a decrease in the probability of an additional refresh operation being performed, the DSD may then perform the refresh operation on sector range 20. However, if the overall change in the total probability instead indicated an increase in the probability of an additional refresh being performed, then the refresh operation on sector range 20 may be deferred until sector range 20 is reevaluated, or until sector range 20 reaches or exceeds the forced refresh threshold value.

By considering the effect of the increase in magnetic interference caused by refresh operations on adjacent and/or proximate sector ranges, the ratio of the number of writes performed for host commands to the number refresh operations performed increases. This reduces the overhead needed for writing host data with fewer refresh operations being performed for a given number of host write commands, which improves the write performance of the DSD by consuming less time and available resources to rewrite data. Decreasing the number of refresh operations that need to be performed to maintain data integrity can also translate to a higher track density and greater overall storage capacity of a recording surface for a given number of total refresh operations, since the overall effect of magnetic interference can be better managed by a more targeted use of the refresh operations.

Those of ordinary skill in the art will appreciate with reference to the present disclosure that the example of FIG. 2 is for the purposes of illustration and that other implementations of determining whether to perform a refresh operation on a sector range may differ. For example, the actual refresh threshold values and indications of accumulated magnetic interference can be much greater in practice, such as in the thousands. In addition, other implementations for determining an indication of accumulated magnetic interference may consider head skew, environmental conditions, and/or FTI or NTI from writes that are, for example, up to twenty tracks away.

### Example Processes

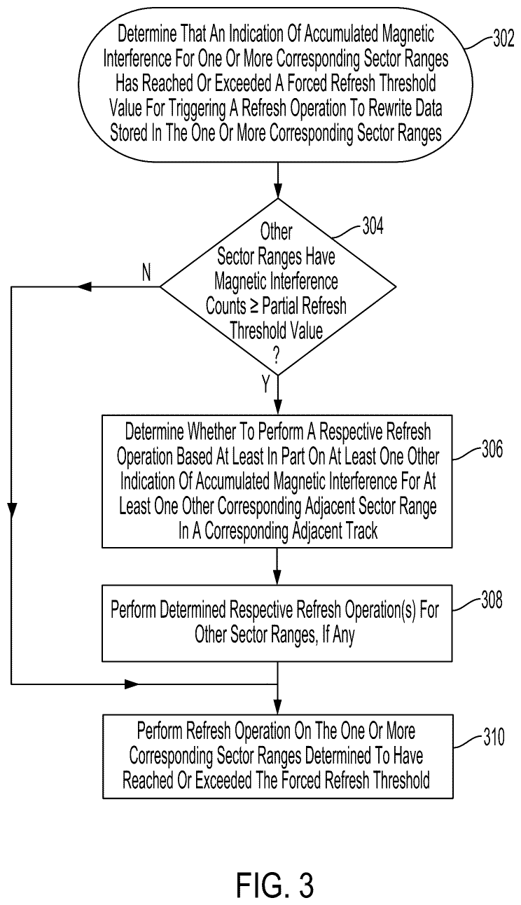

FIG. 3 is a flowchart for a track evaluation process according to one or more embodiments. The process of FIG. 3 can be performed by, for example, circuitry 166 of DSD 100 executing refresh module 10 in FIG. 1. In this regard, circuitry 166 and/or other circuitry of DSD 100 such as AE module 160 can, in some implementations, comprise a means for performing the functions of the track evaluation process.

In block 302, the circuitry determines that an indication of accumulated magnetic interference for one or more corresponding sector ranges has reached or exceeded a forced refresh threshold value for triggering a refresh operation to rewrite data stored in the one or more corresponding sector ranges. In some implementations, this can result from incrementing or updating the indications of accumulated magnetic interference for sector ranges in a track due to one or more write operations in an adjacent track. With reference to the example DSD in FIG. 1, circuitry 166 may increase the indication of accumulated magnetic interference for one or more sector ranges using indications of accumulated magnetic interference 12, and in updating the indications, determine that one or more of the indications of accumulated magnetic interference have reached or exceeded the forced refresh threshold value.

In the process of FIG. 3, the determination in block 302 that one or more sector ranges have an indication of accumulated magnetic interference that has reached or exceeded the forced refresh threshold value (e.g., an indication of accumulated magnetic interference of ten or more) initiates a magnetic interference evaluation process for the other sector ranges included in the same track. The indication of accumulated magnetic interference or a write count for each sector range is checked to determine if the sector range's indication has reached or exceeded a partial refresh threshold value that is less than the forced refresh threshold value. As with the forced refresh threshold value, the partial refresh threshold value can be a predetermined or preset value, such as a value of six as in the example of FIG. 2 discussed above.

The track evaluation process of FIG. 3 can ordinarily reduce the amount of data needed to be rewritten or refreshed by considering the magnetic interference at a sector or sector range level, as opposed to the more conventional evaluation of magnetic interference at a track level, which involves rewriting an entire track if one or more sectors in the track have reached or exceeded the refresh threshold value. However, the finer granularity, or higher resolution, of magnetic interference tracking in the process of FIG. 3 comes at a cost of greater memory consumption, since indications of accumulated magnetic interference are kept for each sector range within the track, as opposed to keeping an indication of accumulated magnetic interference for each track. Typically, the refreshing or rewriting of the sector ranges in a single track can be performed in two revolutions of the disk, with one revolution used to read the data from the sector ranges to be rewritten, and a second revolution to rewrite the data back to the same sector ranges.

In block 304 of FIG. 3, the circuitry determines whether other sector ranges in the track have indications of accumulated magnetic interference that have reached or exceeded (i.e., greater than or equal to) a partial refresh threshold value that is less than the forced refresh threshold value. With reference to the example of FIG. 2 discussed above, the forced refresh threshold value is ten, and the partial refresh threshold value is six. Sector ranges 24 and 26 can trigger or initiate the track evaluation process of FIG. 3 by having indications of accumulated magnetic interference that reach the forced refresh threshold value. Sector ranges 20 and 22 are then evaluated to determine whether to perform a refresh operation, since their indications of accumulated magnetic interference have reached or exceeded the partial refresh threshold value of six.

If none of the other sector ranges in the track has reached or exceeded the partial refresh threshold value, then the track evaluation process proceeds to block 310 to perform the respective refresh operations on the one or more corresponding sector ranges determined in block 302 to have reached or exceeded the forced refresh threshold value.

On the other hand, if it is determined in block 304 that other sector ranges in the track have indications of accumulated magnetic interference that have reached or exceeded the partial refresh threshold value, then it is determined in block 306 whether to perform another respective refresh operation based, at least in part, on at least one other indication of accumulated magnetic interference for at least one other corresponding adjacent sector range in a corresponding adjacent track. The adjacent sector range or sector ranges are adjacent to the evaluated sector in a radial direction on the recording surface. In some implementations, the circuitry may also use the indications of accumulated magnetic interference of other proximate sector ranges, such as sector ranges that are two tracks away from the track, to determine whether to perform the refresh operation on the evaluated sector range.

With reference to the example of FIG. 2 discussed above, the determination of whether to refresh sector ranges 20 and 22 can consider the indications of accumulated magnetic interference of adjacent sector ranges 28 and 30 for sector range 20, and can consider the indication of accumulated magnetic interference of adjacent sector ranges 36 and 38 for sector range 22.

Some implementations may calculate a probability and/or a change in probability for the adjacent sector range's indication of accumulated magnetic interference reaching or exceeding the forced refresh threshold value within a predetermined number of proximate writes to a group of sector ranges centered about the sector range if the refresh operation is performed on the sector range. In some cases, the circuitry may further calculate an overall change in a total probability of any one sector range in the group having an indication of accumulated magnetic interference reaching or exceeding the forced refresh threshold value within respective predetermined numbers of proximate writes.

As noted above, considering the impact of discretionary refresh operations can reduce the overall number of refresh operations that need to be performed for a group of tracks. This reduction in refresh operations scales to the entire recording surface, and further scales across all the recording surfaces in the DSD to reduce the overhead needed to maintain the integrity of the data, despite having a relatively close track pitch on the recording surfaces. As noted above, a closer track pitch (i.e., a higher TPI) increases the data storage capacity of the recording surfaces and also increases the damage caused by magnetic interference when writing data to the closer tracks. However, the increased magnetic interference can be offset by a more efficient use of refresh operations to facilitate a closer track pitch for a given number of refresh operations.

In block 308, the respective refresh operations determined in block 306, if any, are performed for the other sector ranges in the track. In some cases, the circuitry may determine not to perform any additional refresh operations for the other sector ranges that have indications of accumulated magnetic interference that reach or exceed or the partial refresh threshold value. As noted above for block 306, this determination can be due to the impact that the refresh operations would have on adjacent sector ranges or other proximate sector ranges, such as triggering an additional refresh operation or increasing a total probability of an additional refresh operation for a group of sector ranges within a predetermined number of proximate writes.

As noted above, the circuitry in block 310 also performs one or more refresh operations on the one or more corresponding sector ranges determined to have indications of accumulated magnetic interference that have reached or exceeded the forced refresh threshold value in block 302.

Those of ordinary skill in the art will appreciate with reference to the present disclosure that other implementations of a track evaluation process are possible. For example, the performance of refresh operations in blocks 308 and 310 may be combined in practice, such that the order of the performance of the refresh operations corresponds to the relative positions of the sector ranges being refreshed within the track. As another example variation, the refresh operations for sector ranges determined to have indications of accumulated magnetic interference in block 302 that have reached or exceeded the forced refresh threshold value may be performed before evaluating the other sector ranges in the track for whether additional refresh operations should be performed in block 308.

FIG. 4 is a flowchart for a sector range refresh evaluation process according to one or more embodiments. The process of FIG. 4 can be performed by, for example, circuitry 166 of DSD 100 executing refresh module 10 in FIG. 1. In this regard, circuitry 166 and/or other circuitry of DSD 100 such as AE module 160 can, in some implementations, comprise a means for performing the functions of the process of FIG. 4.

In some implementations, the process of FIG. 4 can be a sub-process of a track evaluation process, such as the track evaluation process of FIG. 3 discussed above. In such implementations, the sector range refresh evaluation process of FIG. 4 may be performed for each sector range identified in block 304 that has an indication of accumulated magnetic interference that has reached or exceeded the partial refresh threshold value to determine the overall change in a total probability of an additional refresh operation to rewrite data stored in at least one of the sector range and at least one corresponding adjacent sector range within respective predetermined numbers of proximate writes if the refresh operation were performed on the sector range. Each of the respective predetermined number of proximate writes is performed to one or more sector ranges in a respective group of sector ranges in a radial direction that is centered about a corresponding one of the sector range or an adjacent sector range. In this regard, blocks 402 to 408 of FIG. 4 can comprise a process to determine the overall change in the total probability of the additional refresh operation in at least one of the sector range being evaluated and at least one adjacent sector range within the respective predetermined numbers of proximate writes if the refresh operation were performed on the evaluated sector range.

In block 402 of FIG. 4, the circuitry determines a local change in a local probability of an additional local refresh operation on a sector range within a predetermined number of local proximate writes if the refresh operation were performed on the sector range. As discussed above with reference to the example of FIG. 2, performing the refresh operation on the sector range decreases the local probability of an additional refresh operation on the sector range, since the refresh operation resets the indication of accumulated magnetic interference for the sector range. The predetermined number of local proximate writes is a set of potential future writes performed to one or more sector ranges in a local group of sector ranges in the radial direction that is centered about the sector range. In the example of FIG. 2 discussed above, the local group of sector ranges for sector range 20 (i.e., the sector range being evaluated for a refresh operation) would include sector ranges 28, 20, and 30. The predetermined number of local proximate writes is then for an epoch that would include any five writes to any of sector ranges 28, 20, and 30, assuming the same predetermined number of proximate writes discussed above for FIG. 2. In some implementations, an equation, such as Equation 1 or Equation 2 above, can be used to calculate a local probability after performing the proposed refresh operation, and subtract this probability from a calculated local probability for the case where the refresh operation is not performed.

In block 404 of FIG. 4, the circuitry determines one or more respective adjacent changes in an adjacent probability of a respective adjacent additional refresh operation on an adjacent sector range within a predetermined number of adjacent proximate writes if the refresh operation were performed on the sector range. In some implementations, the adjacent change in the adjacent probability can be determined for each adjacent sector range. Performing the refresh operation on the sector range increases the adjacent probabilities due to the increase in the indications of accumulated magnetic interference for the adjacent sector ranges. The change in the adjacent probability for each adjacent sector range can be calculated using an equation, such as Equations 1 or 2 above, for both cases where the refresh operation is performed on the sector range and where the refresh operation is not performed on the sector range.

In block 406, an overall change is calculated for a total probability of an additional refresh operation by summing the local change in the local probability calculated in block 402 and the one or more respective adjacent changes in the adjacent probability. The sum indicates an expected change in the likelihood of an additional refresh operation within an epoch by performing the refresh operation on the sector range being evaluated.

In block 408, it is determined whether the overall change in the total probability indicates a decrease in the probability of an additional refresh operation. If the overall change in the total probability indicates a decrease, then the refresh operation for the sector range being evaluated is performed in block 412. If the overall change in the total probability indicates an increase or no change, then the refresh operation is not performed on the sector range in block 410, or is deferred until a later point, such as when the indication of accumulated magnetic interference for the sector range reaches or exceeds the forced refresh threshold value or when the sector range is reevaluated for a refresh operation as part of a later track evaluation process.

Those of ordinary skill in the art will appreciate with reference to the present disclosure that other implementations of the refresh determination process of FIG. 4 are possible. For example, the process of FIG. 4 in other implementations may consider changes in probabilities for sector ranges that are farther from the evaluated sector range than its adjacent sector ranges in calculating the overall change in the total probability.

The foregoing systems and methods for refreshing sectors that consider the magnetic interference of the refresh operations themselves can reduce the overall number of refresh operations performed per sector range, which improves the write performance of the DSD by consuming less time and available resources. In addition, the foregoing systems and methods for refreshing sectors can facilitate a greater tolerance of magnetic interference caused by higher track densities due to the better management of refresh operations. This can correspond to a higher track pitch and greater data storage capacity for DSDs that use disk-based storage media.

### OTHER EMBODIMENTS

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium, which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general purpose processor, a GPU, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, removable media, optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

1. A Data Storage Device (DSD), comprising:
one or more disks, wherein each disk of the one or more disks includes at least one recording surface configured to store data in a plurality of tracks on the at least one recording surface, with each track including a plurality of sectors;
at least one memory configured to store one or more data structures configured to account for accumulated magnetic interference on particular sector ranges due, at least in part, to writes performed in proximity to the particular sector ranges, wherein each sector range of the particular sector ranges consists of one or more sectors in a single track that is less than all of the sectors in the single track; and
circuitry configured to:
determine whether to perform a refresh operation on a sector range to rewrite data stored in the sector range based, at least in part, on an indication of accumulated magnetic interference stored in the one or more data structures for the sector range and at least one indication of accumulated magnetic interference stored in the one or more data structures for at least one corresponding adjacent sector range in a corresponding adjacent track to a track including the sector range, wherein the at least one corresponding adjacent sector range is adjacent to the sector range in a radial direction on a recording surface of the one or more disks.

2. The DSD of claim 1, wherein the circuitry is further configured to:
determine that one or more indications of accumulated magnetic interference for one or more corresponding sector ranges in the track have reached or exceeded a forced refresh threshold value for triggering a respective refresh operation to rewrite data stored in the one or more corresponding sector ranges;
in response to determining that the one or more indications of accumulated magnetic interference have reached or exceeded the forced refresh threshold value, determine whether other sector ranges in the track, including the sector range, currently have respective indications of accumulated magnetic interference that have reached or exceeded a partial refresh threshold value, wherein the partial refresh threshold value is less than the forced refresh threshold value; and
for each other sector range in the track determined to have a respective indication of accumulated magnetic interference that has reached or exceeded the partial refresh threshold value, determine whether to perform another respective refresh operation to rewrite data stored in the other sector range based, at least in part, on at least one other indication of accumulated magnetic interference for at least one other corresponding adjacent sector range in the corresponding adjacent track, wherein the at least one other corresponding adjacent sector range is adjacent to the other sector range in a different radial direction on the recording surface.

3. The DSD of claim 1, wherein the circuitry is further configured to:
determine an adjacent probability of the indication of accumulated magnetic interference for an adjacent sector range of the at least one corresponding adjacent sector range reaching or exceeding a forced refresh threshold value within a predetermined number of writes to one or more sector ranges in a group of sector ranges including the sector range, the adjacent sector range, and a proximate sector range on an opposite side of the adjacent sector range from the sector range in the radial direction, with the proximate sector range being in a proximate track adjacent to the corresponding adjacent track that includes the adjacent sector range; and
wherein the indication of accumulated magnetic interference for the adjacent sector range reaching or exceeding the forced refresh threshold value triggers an additional refresh operation on the adjacent sector range to rewrite data stored in the adjacent sector range.

4. The DSD of claim 3, wherein the adjacent probability is based, at least in part, on a probability of a write of the predetermined number of writes being performed to the sector range or to the proximate sector range.

5. The DSD of claim 3, wherein the adjacent probability is based, at least in part, on a difference between the forced refresh threshold value and the indication of accumulated magnetic interference for the adjacent sector range.

6. The DSD of claim 3, wherein the adjacent probability is based, at least in part, on the average of, or the greater of, the effect on the indication of accumulated magnetic interference for the adjacent sector range that is caused by a write to the sector range and the effect on the indication of accumulated magnetic interference for the adjacent sector range that is caused by a different write to the proximate sector range.

7. The DSD of claim 3, wherein the circuitry is further configured to:
determine an increase in the adjacent probability if the refresh operation were performed on the sector range.

8. The DSD of claim 1, wherein the circuitry is further configured to:
determine an overall change in a total probability of an additional refresh operation to rewrite data stored in at least one of the sector range and the at least one corresponding adjacent sector range within respective predetermined numbers of writes if the refresh operation were performed on the sector range, wherein each of the respective predetermined numbers of writes is performed to one or more sectors in a respective group of proximate sector ranges in the radial direction that is respectively centered about a corresponding one of the sector range or an adjacent sector range of the at least one corresponding adjacent sector range.

9. The DSD of claim 8, wherein the circuitry is further configured to:
determine a local change in a local probability of a local additional refresh operation on the sector range within a predetermined number of local proximate writes if the refresh operation were performed on the sector range, wherein performing the refresh operation on the sector range decreases the local probability of the local additional refresh operation on the sector range, and wherein the predetermined number of local proximate writes is performed to one or more sector ranges in a local group of sector ranges in the radial direction that is centered about the sector range;
for each adjacent sector range of the at least one corresponding adjacent sector range, determine an adjacent change in an adjacent probability of an adjacent additional refresh operation on the adjacent sector range within a predetermined number of adjacent proximate writes if the refresh operation were performed on the sector range, wherein performing the refresh operation on the sector range increases the adjacent probability of the adjacent additional refresh operation on the adjacent sector range, and wherein the predetermined number of adjacent proximate writes is performed to one or more sector ranges in an adjacent group of sector ranges in the radial direction that is centered around the adjacent sector range;
calculate the overall change in the total probability of the additional refresh operation by summing the local change in the local probability and each determined adjacent change in the adjacent probability;
in response to the calculated overall change in the total probability indicating a decrease in probability of the additional refresh operation, perform the refresh operation on the sector range; and
in response to the calculated overall change in probability indicating an increase in probability of the additional refresh operation, defer performing the refresh operation on the sector range.

10. A method for a Data Storage Device (DSD) including one or more disks, the method comprising:
determining that a sector range in a track on a recording surface of the one or more disks has an indication of accumulated magnetic interference that has reached or exceeded a partial refresh threshold value, wherein the partial refresh threshold value is less than a forced refresh threshold value that triggers a refresh operation to rewrite data stored in the sector range in response to the indication of accumulated magnetic interference reaching or exceeding the forced refresh threshold value; and
in response to determining that the sector range has an indication of accumulated magnetic interference that has reached or exceeded the partial refresh threshold value, determining whether to proactively perform the refresh operation on the sector range to rewrite data stored in the sector range based, at least in part, on at least one indication of accumulated magnetic interference for at least one corresponding adjacent sector range in a corresponding adjacent track to the track, wherein the at least one corresponding adjacent sector range is adjacent to the sector range in a radial direction on the recording surface.

11. The method of claim 10, further comprising:
determining that one or more indications of accumulated magnetic interference for one or more corresponding sector ranges in the track have reached or exceeded the forced refresh threshold value for triggering a respective refresh operation to rewrite data stored in the one or more corresponding sector ranges;
in response to determining that the one or more indications of accumulated magnetic interference have reached or exceeded the forced refresh threshold value, determining whether other sector ranges in the track, including the sector range, currently have respective indications of accumulated magnetic interference that have reached or exceeded the partial refresh threshold value; and
for each other sector range in the track determined to have an indication of accumulated magnetic interference that has reached or exceeded the partial refresh threshold value, determining whether to proactively perform another respective refresh operation to rewrite data stored in the other sector range based, at least in part, on at least one other indication of accumulated magnetic interference for at least one other corresponding adjacent sector range in the corresponding adjacent track, wherein the at least one other corresponding adjacent sector range is adjacent to the other sector range in a different radial direction on the recording surface.

12. The method of claim 10, further comprising:
determining an adjacent probability of the indication of accumulated magnetic interference for an adjacent sector range of the at least one corresponding adjacent sector range reaching or exceeding the forced refresh threshold value within a predetermined number of writes to one or more sector ranges in a group of sector ranges including the sector range, the adjacent sector range, and a proximate sector range on an opposite side of the adjacent sector range from the sector range in the radial direction, with the proximate sector range being in a proximate track adjacent to the corresponding adjacent track that includes the adjacent sector range; and
wherein the indication of accumulated magnetic interference for the adjacent sector range reaching or exceeding the forced refresh threshold value triggers an additional refresh operation on the adjacent sector range to rewrite data stored in the adjacent sector range.

13. The method of claim 12, wherein the adjacent probability is based, at least in part, on a probability of a write of the predetermined number of writes being performed to the sector range or to the proximate sector range.

14. The method of claim 12, wherein the adjacent probability is based, at least in part, on a difference between the forced refresh threshold value and the indication of accumulated magnetic interference for the adjacent sector range.

15. The method of claim 12, wherein the adjacent probability is based, at least in part, on the average of, or the greater of, the effect on the indication of accumulated magnetic interference for the adjacent sector range that is caused by a write to the sector range and the effect on the indication of accumulated magnetic interference for the adjacent sector range that is caused by a different write to the proximate sector range.

16. The method of claim 12, further comprising:
determining an increase in the adjacent probability if the refresh operation were performed on the sector range.

17. The method of claim 10, further comprising:
determining an overall change in a total probability of an additional refresh operation to rewrite data stored in at least one of the sector range and the at least one corresponding adjacent sector range within respective predetermined numbers of writes if the refresh operation were performed on the sector range, wherein each of the respective predetermined numbers of writes is performed to one or more sector ranges in a respective group of proximate sector ranges in the radial direction that is respectively centered about a corresponding one of the sector range or an adjacent sector range of the at least one corresponding adjacent sector ranges.

18. The method of claim 17, further comprising:
determining a local change in a local probability of a local additional refresh operation on the sector range within a predetermined number of local proximate writes if the refresh operation were performed on the sector range, wherein performing the refresh operation on the sector range decreases the local probability of the local additional refresh operation on the sector range, and wherein the predetermined number of local proximate writes is performed to one or more sector ranges in a local group of sectors in the radial direction that is centered about the sector range;
for each adjacent sector range of the at least one corresponding adjacent sector range, determining an adjacent change in an adjacent probability of an adjacent additional refresh operation on the adjacent sector range within a predetermined number of adjacent proximate writes if the refresh operation were performed on the sector range, wherein performing the refresh operation on the sector range increases the adjacent probability of the adjacent additional refresh operation on the adjacent sector range, and wherein the predetermined number of adjacent proximate writes is performed to one or more sector ranges in an adjacent group of sectors in the radial direction that is centered about the adjacent sector range;
calculating the overall change in the total probability of the additional refresh operation by summing the local change in the local probability and each determined adjacent change in the adjacent probability;
in response to the calculated overall change in the total probability indicating a decrease in probability of the additional refresh operation, performing the refresh operation on the sector range; and
in response to the calculated overall change in probability indicating an increase in probability of the additional refresh operation, deferring performing the refresh operation on the sector range.

19. A Data Storage Device (DSD), comprising:
one or more disks, wherein each disk of the one or more disks includes at least one recording surface configured to store data in a plurality of tracks on the at least one recording surface, with each track including a plurality of sectors;
at least one memory configured to store one or more data structures configured to account for magnetic interference on particular sector ranges due, at least in part, to writes performed in proximity to the particular sector ranges, wherein each sector range of the particular sector ranges consists of one or more sectors in a single track that is less than all of the sectors in the single track; and
means for:
determining whether to perform a refresh operation on a sector range to rewrite data stored in the sector range based, at least in part, on an indication of accumulated magnetic interference stored in the one or more data structures for the sector range and at least one indication of accumulated magnetic interference stored in the one or more data structures for at least one corresponding adjacent sector range in a corresponding adjacent track to a track including the sector range, wherein the at least one corresponding adjacent sector range is adjacent to the sector range in a radial direction on a recording surface of the one or more disks.

20. The DSD of claim 19, further comprising means for:
determining an adjacent probability of the indication of accumulated magnetic interference for an adjacent sector range of the at least one corresponding adjacent sector range reaching or exceeding a forced refresh threshold value within a predetermined number of writes to one or more sector ranges in a group of sector ranges including the sector range, the adjacent sector range, and a proximate sector range on an opposite side of the adjacent sector range from the sector range in the radial direction, with the proximate sector range being in a proximate track adjacent to the corresponding adjacent track that includes the adjacent sector range; and
wherein the indication of accumulated magnetic interference for the adjacent sector range reaching or exceeding the forced refresh threshold value triggers an additional refresh operation on the adjacent sector range to rewrite data stored in the adjacent sector range.
